(19) United States
(12) Patent Application Publication
(10) Pub. No.: US 2004/0121765 A1
(43) Pub. Date: Jun. 24, 2004

(54) Method and apparatus for maintaining sip contact addresses using event subscription

(76) Inventors: Ajaykumar R. Idnani, Schaumburg, IL (US); Steven Upp, Bartlett, IL (US); Thomas G. Hallin, Wheaton, IL (US)

Correspondence Address: MOTOROLA, INC., 1303 EAST ALGONQUIN ROAD, IL01/3RD, SCHAUMBURG, IL, 60196

(21) Appl. No.: 10/625,385

(22) Filed: Jul. 23, 2003

Related U.S. Application Data
(60) Provisional application No. 60/413,107, filed on Sep. 24, 2002.

(51) Int. Cl. G06F 15/16; H04L 12/66

(52) U.S. Cl. 455/422.1; 455/432.1; 455/435.1; 709/227; 370/352

(57) ABSTRACT

The present application describes various embodiments that address the need in wireless environments and within the SIP framework to efficiently maintain SIP contact addresses. It introduces the concept of a SIP proxy user agent (UA) (e.g., 123 or 124) to serve as a gateway between a SIP core network and a SIP-unaware mobile (101). A new message is described, a combined registration and event subscription message, which is used by SIP proxy UAs to both register a new contact address for a mobile and to subscribe to the mobile's contact information. By updating and subscribing to the contact information, a SIP proxy UA is notified of subsequent changes to a mobile's contact information. Registration and deregistration of contact addresses can thus be effected in a manner that allows SIP contact addresses to be more efficiently maintained.

### REFERENCE(S) TO RELATED APPLICATION(S)

The present application claims priority from provisional application, Serial No. 60/413,607, entitled “METHOD AND APPARATUS FOR MAINTAINING SIP CONTACT ADDRESSES USING EVENT SUBSCRIPTION,” filed Sep. 24, 2003, which is commonly owned and incorporated herein by reference in its entirety.

### CROSS-REFERENCE TO RELATED APPLICATION

This application is related to a co-pending application entitled “METHOD AND APPARATUS FOR MAINTAINING SIP CONTACT ADDRESSES,” filed on even date herewith, assigned to the assignee of the instant application, and hereby incorporated by reference.

### FIELD OF THE INVENTION

The present invention relates generally to wireless communications and, in particular, to maintaining SIP contact addresses within radio access networks.

### BACKGROUND OF THE INVENTION

Next generation wireless communication systems are being designed provide a variety of internet-based services. To support such services, protocols such as the Session Initiation Protocol (SIP) are being adopted and incorporated into these systems. SIP is a text-based protocol, similar to HTTP and SMTP, for initiating interactive communication sessions between users. Such sessions include voice, video, chat, interactive games, and virtual reality. The Internet Engineering Task Force (IETF) may be contacted for a complete description of the SIP standard.

To incorporate SIP into wireless systems, however, limitations such as the air interface and user mobility must be addressed. For example, SIP uses contact addresses to tie a user's address-of-record to his/her location. The contact addresses are centrally registered with a SIP Registrar using SIP REGISTER messages. However, SIP currently lacks the robustness to efficiently maintain contact addresses for mobile units as they move across service areas, at least in certain wireless implementations of SIP. Therefore, a need exists within the SIP framework for an apparatus and method to effectively and efficiently maintain SIP contact addresses in wireless environments.

### BRIEF DESCRIPTION OF THE DRAWINGS

FIG. 1 is a block diagram depiction of a wireless communication system in accordance with an embodiment of the present invention.

FIG. 2 is a call flow depiction of messaging between system elements in accordance with an embodiment of the present invention.

### DETAILED DESCRIPTION OF EMBODIMENTS

The present application describes various embodiments that address the need in wireless environments and within the SIP framework to efficiently maintain SIP contact addresses. It introduces the concept of a SIP proxy user agent (UA) to serve as a gateway between a SIP core network and a SIP-unaware mobile. A new message is described, a combined registration and event subscription message, which is used by SIP proxy UAs to both register a new contact address for a mobile and to subscribe to the mobile's contact information. By updating and subscribing to the contact information, a SIP proxy UA is notified of subsequent changes to a mobile's contact information. Registration and deregistration of contact addresses can thus be effected in a manner that allows SIP contact addresses to be more efficiently maintained.

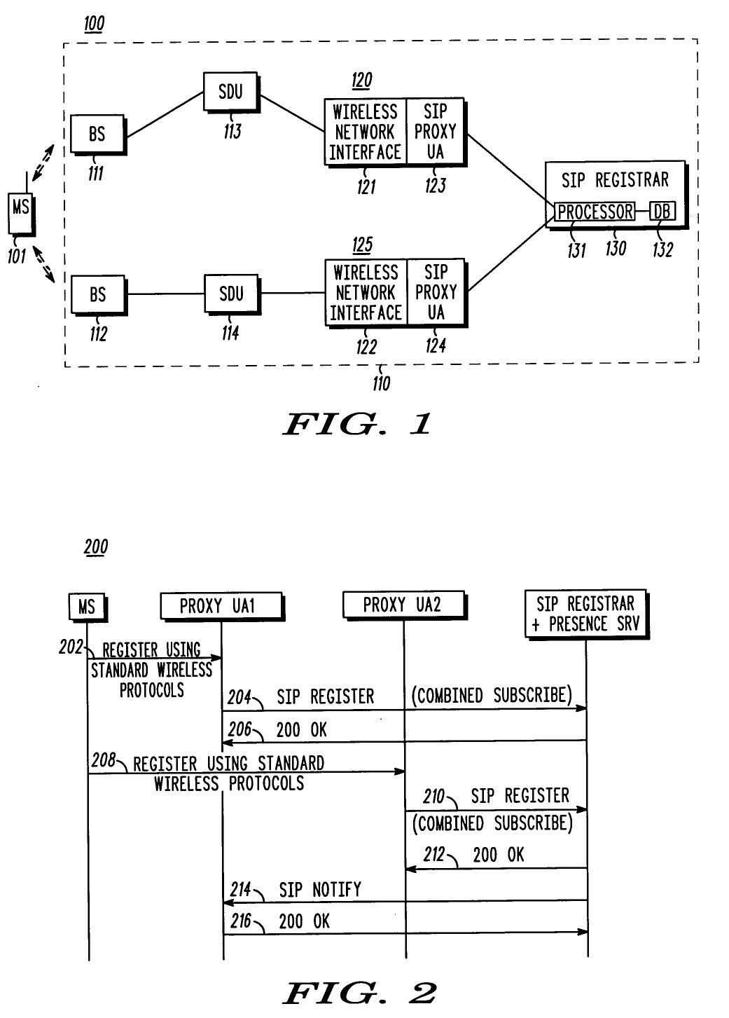

The disclosed embodiments can be more fully understood with reference to FIGS. 1 and 2. FIG. 1 is a block diagram depiction of a wireless communication system 100 in accordance with a first embodiment of the present invention. Communication system 100 is a well-known Code Division Multiple Access (CDMA) system, specifically a CDMA 2000 system, which is based on the Telecommunications Industry Association/Electronic Industries Association (TIA/EIA) standard IS-2000, suitably modified to implement the present invention. However, the present invention is not limited to a particular wireless technology. Therefore, in alternate embodiments, communication system 100 may utilize other communication system protocols such as, but not limited to, “iDEN,” UMTS, 1x EVDV, 1x EVDO, GPRS, EDGE, and WLANs.

The first embodiment of the present invention includes a radio access network (RAN) 110 and remote units, such as mobile station (MS) 101. However, the present invention is not limited to remote units that are mobile. For example, a remote unit may comprise a desktop computer wirelessly connected to the radio access network.

Those skilled in the art will recognize that FIG. 1 does not depict all of the network equipment necessary for system 100 to operate but only those logical entities particularly relevant to the description of embodiments of the present invention. For example, system 100 comprises well-known entities such as base sites 111 and 112, frame selection and distribution units (SDUs) 113 and 114, SIP components 120 and 125 (each comprising a wireless network interface (121 and 122) and a SIP proxy UA (123 and 124)), and SIP registrar/presence server 130. Those skilled in the art are aware of the many ways each of these entities can be implemented and/or purchased from wireless communications companies such as “MOTOROLA.”

SIP components 120 and 125 and SIP registrar/presence server 130 comprise well-known data communication entities such as wireless network interfaces 121 and 122, processor 131, and SIP location database 132. SIP components 120 and 125 also comprise data communication entities such as SIP proxy UAs 123 and 124, which are based on well-known SIP UAs. However, SIP proxy UAs serve as a SIP gateway for SIP-unaware units that are not themselves SIP UAs. All of these data communication entities typically comprise components such as microprocessors, memory, and/or logic circuitry designed to implement particular algorithms and/or protocols. Given such an algorithm, protocol definition (e.g., IETF's SIP specification), or logic flow, those skilled in the art are aware of the many design and development techniques available to implement SIP components and SIP registrars to perform the given logic.

Although not explicitly shown, system 100 further comprises base transceiver stations (BTSs), which interface with devices such as base site controllers (BSCs), mobile switching centers/virtual location registers (MSC/VLRs), home location registers (HLRs), etc. In the first embodiment of the present invention, a known CDMA 2000 RAN is adapted using known telecommunications design and development techniques to implement the logic of the present invention. The result is RAN 110, which performs the method described with respect to FIG. 2. Those skilled in the art will recognize that the present invention may be implemented in and across various physical components of RAN 110, not just on the physical processing platforms of SIP components 120 and 125 and SIP registrar/presence server 130 as illustrated in FIG. 1.

Operation of the first embodiment, in accordance with the present invention, occurs substantially as follows. As shown in FIG. 1, MS 101 may obtain wireless services from RAN 110 via either base site 111 or 112. However, as RAN 110 is architected, a different SIP component serves the two wireless service areas of base sites 111 and 112. When MS 101 begins obtaining service from BS 111 it sends a registration request message to SIP component 120. This registration request message is not a SIP message, but rather a registration message in accordance with the wireless protocol utilized by MS 101 (e.g., CDMA 2000).

FIG. 2 is a call flow depiction of the messaging between system elements in accordance with the first embodiment of the present invention. MS 101's registration request (or update presence) message 202 is shown in call flow diagram 200. Message 202 is received by SIP proxy UA 123 via wireless network interface 121. Acting as a proxy user agent for MS 101, SIP proxy UA 123 then sends a combined registration and event subscription message for MS 101 to SIP registrar/presence server 130. Thus, proxy UAs act as gateways between the SIP core network and the SIP-unaware mobile. Proxy UAs are responsible for running the UA call engine for each of the mobiles they serve, and additionally, for translating the call control messaging between SIP and the appropriate wireless protocol.

In conjunction with the proxy UAs, SIP registrars maintain a list of contact addresses for each of the mobiles that they serve. Generally, when a SIP registrar receives a SIP REGISTER message for a remote unit, it obtains the contact address from the message and adds it to the list of contact addresses for that unit. In addition, when a SIP presence server receives a SIP SUBSCRIBE request message from another SIP entity, it subscribes that entity to the presence information of the indicated unit. When the presence information changes, the presence server sends a NOTIFY message to the subscribing entities. In the first embodiment of the present invention, a SIP registrar and a SIP presence server are combined. Thus, SIP registrar/presence server 130 performs both registration and subscription functions.

After receiving MS 101's registration request, i.e., message 202, SIP proxy UA 123 sends a combined registration and event subscription message for MS 101 to SIP registrar/presence server 130. In the first embodiment, the combined registration and event subscription message comprises a SIP REGISTER message that has an additional indication of an event to which SIP proxy UA 123 requests subscription. Thus, combined SIP REGISTER message 204 comprises the following information:

REGISTER sip:registrar.home.com

Via: SIP/2.0/UDP proxyUA1.visited.com:5060

From:UserA <userA@home.com>

To: UserA <userA@home.com>

Accept: application/cpim-pidf+xml

Call-ID: 123456@proxyUA1.visited.com

Cseq: 14 REGISTER

Contact: userA@proxyUA1.visited.com; tag=5551212

Event: presence

Expires: 7200

Content-Length: 0

Combined SIP REGISTER message 204 includes a SIP SUBSCRIBE message Event header, which indicates a request to subscribe to contact address changes, or alternatively, to presence information changes for MS 101. Effectively then, combined SIP REGISTER message 204 comprises a combination of the headers of a SIP REGISTER message and a SIP SUBSCRIBE message so that an explicit SIP SUBSCRIBE message need not be sent.

Upon receiving message 204, processor 131 of SIP registrar/presence server 130 stores the contact address provided, “userA@proxyUA1.visited.com”, as the contact address for MS 101 in SIP location database 132. Performing presence server functionality, processor 131 also subscribes SIP proxy UA 123 to MS 101's contact information as requested by combined SIP REGISTER message 204. In response to message 204, SIP registrar 130 sends SIP 200 OK message 206 to SIP proxy UA 123. SIP 200 OK message 206 comprises the following information, including all the current contact addresses for MS 101:

SIP/2.0 200 OK

Via: SIP/2.0/UDP registrar.home.com:5060

From:UserA <userA@home.com>

To: UserA <userA@home.com>

Call-ID: 123456@proxyUA1.visited.com

Cseq: 14 REGISTER

Contact: userA@proxyUA1.visited.com

Content-Length:0

When MS 101 begins obtaining service from BS 112 it sends a non-SIP registration request message to SIP component 125. This registration request message 208 is received by SIP proxy UA 124 via wireless network interface 122. Acting as a proxy user agent for MS 101, SIP proxy UA 124 then translates the registration request into combined SIP REGISTER message 210 and sends it to SIP registrar 130 for MS 101. Combined SIP REGISTER message 210 comprises the following information:

REGISTER sip:registrar.home.com

Via: SIP/2.0/UDP proxyUA2.visited.com:5060

From:UserA <userA@home.com>

To: UserA <userA@home.com>

Accept: application/cpim-pidf+xml

Call-ID: 63158@proxyUA2.visited.com

Cseq: 1 REGISTER

Contact: userA@proxyUA2.visited.com;tag=5551212

Event: presence

Expires: 7200

Content-Length: 0

Message 210 is also a combined registration and event subscription message that includes a SIP SUBSCRIBE message Event header. However, message 210 need not have been a combined registration message, as a SIP REGISTER message would suffice to establish a new contact address for MS 101.

Upon receiving message 210, SIP registrar/presence server 130 updates the contact address information for MS 101. In the first embodiment, processor 131 of SIP registrar/presence server 130 stores the new contact address provided, “userA@proxyUA2.visited.com”, as the new contact address for MS 101 in SIP location database 132. However, in an alternative embodiment of the present invention, the new contact address may not replace the old address but may be merely added to the list of contact addresses for MS 101. In addition to updating the contact information, processor 131 also subscribes SIP proxy UA 124 to MS 101's contact information as requested by combined SIP REGISTER message 210. Also in response to message 210, SIP registrar 130 sends SIP 200 OK message 212 to SIP proxy UA 124. SIP 200 OK message 212 indicates MS 101's current contact address and comprises the following information:

SIP/2.0 200 OK

Via: SIP/2.0/UDP registrar.home.com:5060

From:UserA <userA@home.com>

To: UserA <userA@home.com>

Call-ID: 63158@proxyUA2.visited.com

Cseq: 1 REGISTER

Contact: userA@proxyUA2.visited.com

Content-Length:0

As a result of combined SIP REGISTER message 210 MS 101's contact information was updated. Since SIP proxy UA 123 is subscribed to MS 101's contact information, SIP registrar/presence server 130 notifies the SIP proxy UA 123 that the contact information for MS 101 has changed. Specifically in the first embodiment, registrar 130 sends SIP NOTIFY message 214 to proxy UA 123, which indicates that the old contact address is being replaced by the new contact address indicated in message 214. A SIP NOTIFY message would also be sent in an alternate embodiment in which the new contact address was merely added to MS 101's contact information. SIP NOTIFY message 214 indicates MS 101's new contact address and comprises the following information:

NOTIFY sip:userA@proxyUA1.visited.com

Via: SIP/2.0/UDP registrar.home.com:5060

From:UserA <userA@home.com>

To: UserA <userA@home.com>

Call-ID: 123456@proxyUA1.visited.com

Cseq: 1 NOTIFY

Contact: userA@proxyUA2.visited.com

Content-Type: application/cpim-pidf+xml

In response to receiving SIP NOTIFY message 214, SIP proxy UA 123 sends SIP 200 OK message 216 to SIP registrar/presence server 130. SIP 200 OK message 216 includes the current contact address for MS 101 and comprises the following information:

SIP/2.0 200 OK

Via: SIP/2.0/UDP proxyUA1.visited.com:5060

From:UserA <userA@home.com>

To: UserA <userA@home.com>

Call-ID: 123456@proxyUA1.visited.com

Cseq: 1 NOTIFY

Contact: userA@proxyUA2.visited.com

Content-Length:0

Call flow 200 thus is completed.

In call flow 200 above, when the unit moves to a new service area, the new proxy UA in that area registers the contact address with the SIP registrar and subscribes to that unit's contact information. Because the new registration causes the contact information of the unit to change, those SIP proxy UAs which are already subscribed to the contact information are notified of the changes. A new contact address can replace an old address (i.e., registration/deregistration) and the appropriate SIP proxy UA(s) is informed of the effective registration and deregistration of the new and old addresses.

It is this process for registering/deregistering SIP proxy UAs that allows SIP contact addresses to be more efficiently maintained. Before, when a unit moved from one service area to another, its registration at the old service area (i.e., at the proxy UA for that area) and at the SIP registrar would often be kept active until expiring. As a result, system resources were wasted since messaging such as SIP INVITEs are forked to the entire contact list. Thus, efficiently removing old contact addresses as described herein can reduce unnecessary network traffic.

In the foregoing specification, the present invention has been described with reference to specific embodiments. However, one of ordinary skill in the art will appreciate that various modifications and changes may be made without departing from the spirit and scope of the present invention as set forth in the appended claims. For example, “presence” is given as an example of an event and “presence server” is referred to as a type of event server throughout the foregoing specification. However, these references are merely illustrative and could be replaced with other types of events and event servers, all within the scope of the present claims. Accordingly, the specification and drawings are to be regarded in an illustrative rather than a restrictive sense, and all such modifications are intended to be included within the scope of the present invention. In addition, those of ordinary skill in the art will appreciate that the elements in the drawings are illustrated for simplicity and clarity. For example, the dimensions of some of the elements in the drawings may be exaggerated relative to other elements to help improve an understanding of the various embodiments of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically or electrically. The term “program” (or “programming”), as used herein, is defined as a sequence of instructions designed for execution on a computer system. A program, programming, or computer program, may include a subroutine, a function, a procedure, an object method, an object implementation, an executable application, an applet, a servlet, a source code, an object code, a shared library/dynamic load library and/or other sequence of instructions designed for execution on a computer system.

What is claimed is:

1. A method for maintaining SIP contact addresses using event subscription:
receiving, by a SIP proxy user agent (UA), a non-SIP registration request from a remote unit;
sending, in response to the registration request, a combined registration and event subscription message for the remote unit to a SIP registrar; and
receiving, from the SIP registrar, a notification that indicates that an old contact address based on the combined registration and event subscription message is being replaced by a new contact address for the remote unit.

2. The method of claim 1 wherein the combined registration and event subscription message comprises a SIP REGISTER message and an indication of an event to which the SIP proxy UA subscribes.

3. The method of claim 2 wherein the event to which the SIP proxy UA subscribes is contact address changes.

4. The method of claim 2 wherein the combined registration and event subscription message comprises a SIP REGISTER message and a SIP SUBSCRIBE message Event header.

5. The method of claim 1 wherein the notification further indicates the new contact address for the remote unit.

6. The method of claim 5 wherein the notification comprises a SIP NOTIFY message.

7. A method for maintaining SIP contact addresses using event subscription:
receiving a combined registration and event subscription message for a remote unit from a first SIP proxy user agent (UA);
storing, as contact information for the remote unit, a first contact address based on the combined registration and event subscription message;
in response to receiving the combined registration and event subscription message, subscribing the first SIP proxy UA to the contact information for the remote unit;
receiving a registration message for the remote unit from a second SIP proxy UA after receiving the combined registration and event subscription message;
updating the contact information with a second contact address based on the registration message; and
notifying the first SIP proxy UA that the contact information for the remote unit has changed.

8. The method of claim 7 wherein the combined registration and event subscription message comprises a SIP REGISTER message and an indication of an event to which the SIP proxy UA subscribes.

9. The method of claim 8 wherein the combined registration and event subscription message comprises a SIP REGISTER message and a SIP SUBSCRIBE message Event header.

10. The method of claim 7 wherein notifying comprises notifying the first SIP proxy UA of the new contact address for the remote unit.

11. The method of claim 10 wherein notifying comprises notifying the first SIP proxy UA that the second contact address has replaced the first contact address.

12. The method of claim 11 wherein the notification comprises a SIP NOTIFY message.

13. The method of claim 7 wherein the registration message comprises a combined registration and event subscription message.

14. A radio access network (RAN) component comprising:
a wireless network interface; and
a SIP proxy user agent, communicatively coupled to the wireless network interface, adapted to
receive via the wireless network interface a non-SIP registration request from a remote unit,
send, in response to the registration request, a combined registration and event subscription message for the remote unit to a SIP registrar, and
receive, from the SIP registrar, a notification that indicates that an old contact address based on the combined registration and event subscription message is being replaced by a new contact address for the remote unit.

15. A SIP registrar comprising:
a SIP location data base; and
a SIP registration processor, communicatively coupled to the SIP registration data base, adapted to
receive a combined registration and event subscription message for a remote unit from a first SIP proxy user agent (UA),
store in the SIP location data base, as contact information for the remote unit, a first contact address based on the combined registration and event subscription message,
in response to receiving the combined registration and event subscription message, subscribe the first SIP proxy UA to the contact information for the remote unit,
receive a registration message for the remote unit from a second SIP proxy UA after receiving the combined registration and event subscription message,
update the contact information with a second contact address based on the registration message, and
notify the first SIP proxy UA that the contact information for the remote unit has changed.
